(19) United States
(12) Patent Application Publication
(10) Pub. No.: US 2011/0016029 A1
(43) Pub. Date: Jan. 20, 2011

(54) Group Opt Out theft Identity Services For Financial Account Holder Method

(76) Inventors: Sally M. King, Brentwood, TN (US); Scott F. Smith, Franklin, TN (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 12/346,244

(22) Filed: Dec. 30, 2008

(51) Int. Cl. G06Q 40/00; G06Q 30/00; G06Q 10/00

(52) U.S. Cl. 705/34; 705/400; 705/30; 705/35

(57) ABSTRACT

Identity theft services, made available as an inherent part of a financial services account with an optional fee structure, are believed to provide economical and attractive option to the market place, and an additional safeguard to the financial organization from the effects of fraud and security breach. By providing notice followed by a period to opt out and then instituting a new identity theft service, a revenue generating stream can be provided for a financial organization as well as a service provider. Furthermore, the customers at the financial organization are provided with identity theft service benefits not previously enjoyed. When utilizing this service with a Covered Group, even those individuals that opt out may be provided at least limited identity theft services.

The present invention relates to a business method of providing a featured financial service through a financial institution, association or other qualifying organization (collectively “financial organization”) to an account holder, member, subscriber or other qualifying accountholder (collectively “customers”), and more particularly in a preferred embodiment to a process of providing economically attractive identity theft services to a pool of customers through a service provider, preferably on an opt-out basis for some services, while possibly providing other services for all in the pool.

### BRIEF DESCRIPTION OF RELATED ART

With identity theft and information security breaches rampant in today's world, a need for identity theft services appears to continue to accelerate. Consumers are believed to view identity theft resolution as a high value, high expense item. Currently, there are believed to be only two choices for financial organizations and their customers to obtain identity theft services, a voluntary purchase product and a blanket coverage product.

First, some customers currently elect “voluntary purchase” services or products. The customer voluntarily and affirmatively subscribes to an identity theft protection service in contract with a specific company for specific services. These voluntary purchase products may cost as much or more as $150.00 per year and must be in place before the customers are victimized. After an identity theft crime has been committed, purchasing the same services could be expected to cost thousands of dollars. While a financial organization could sponsor such programs for its customers, any and all participating customers would need to affirmatively sign up for such services with a provider.

Secondly, financial organizations could offer a blanket of services. A specific identity theft benefit could be provided by the financial organization on behalf of at least a selected group of customers or in some embodiments imbedded into a package of services attached to the account. This service as currently provided with a small fee to offset the cost for packaged services or as an expense to the financial institution which is not passed on to the consumer directly for the service being provided. Accordingly, neither of these options is a profit center for the financial institution with this second option sometimes being a direct cost.

In the world of tightening budgets for financial organizations, another option is believed to be attractive. In short, an improved business method is believed to be desirable for providing identity theft related services to customers of financial organizations.

### SUMMARY OF THE INVENTION

It is an object of the present invention to provide a new business method related to providing identity theft services to at least a group of customers at a financial organization.

It is another object of at least some embodiments of the present invention to provide the identity theft services as an account feature giving the customer the opportunity to opt-out of the identity theft recovery service as provided for financial organization customers.

It is still another object of at least some embodiments of the present invention to provide an affordable identity theft service product which can cover family members of a customer (i.e., not just the named customer).

It is still another object of at least some embodiments of the present invention whereby in an event of a security breach at a financial organization, all customers of at least a group at the financial organization are at least personally covered for identity theft services including those who have opted out.

In accordance with a presently preferred embodiment of the present invention a business method is provided wherein a financial organization such as banks, credit unions, savings and loans, brokerages, association, membership companies, etc., or other financial organizations that provide financial accounts for customers identify at least a group of customers or population that the organization would like covered as a portion of a “Covered Group.” A retail price of services then arrived upon. It is possible in some embodiments that a markup may be added to an expected profit margin at the financial organization to assist at arriving at the retail price. It is possible to charge a base price with the mark up as a retail price to pass along as the cost per account (or customer) per month or other interval. The customers are notified of the benefit being added to the account. Notification may take a variety of forms. The notice as provided offers to each customer an option to drop out of the cover group and not participate in at least some of the benefits. The customers who elect to opt-out may be provided the benefit for a predetermined period of time, such as up to sixty days, possibly along with those who do not opt-out so that a service program can be added to all of the account holders in the Covered Group or just to the Selected Group (i.e., those in the Covered Group that have not opted out).

The service can initially be provided at no cost for this notification period in some embodiments. After the notification period, the Selected Group's accounts are charged the selected retail price. Those that opt-out are not charged. If at any time a customer in the Covered Group states they did not have the opportunity to opt out or wishes to dispute a charge, a refund can be provided preferably up to a predetermined refund period such as six months.

At the end of each period such as each month, a total amount collected for the services is then summed. The fees the financial institution has collected minus the administration fee, markup, if any, and account cancellations can be calculated. A remittance of the remainder can be made to the service provider.

If any customer in the Covered Group and/or Selected Group should be determined to have a qualifying identity theft event of his or possibly a member of his family's identity, the financial organization can verify the account holder is a member of the Covered Group or Selected Group, as applicable. One preferred way to open a case is to use the financial organization's log-in and password to open the case assuming that the financial organization believes the account holder qualifies for the service sought. Other methods of opening a case may be used, such as a telephone call or other method. The account holder's name, telephone number and a best time to call are preferably provided to the identity theft recovery service. The case is then preferably submitted to a recovery care center and an advocate is then assigned to the victim and which can preferably call the account holder within 24 business hours if not 1-3 hours. Based on a possible cost of about, more or less than $1.00 per customer and a typical acceptance rate of exceeding 80%, one can see that the revenue generated per month could be considerable for the financial organization preferably when tens of thousands of customers or more are at issue.

Furthermore, the service provided preferably includes family coverage so that if any member of a customer's family becomes a victim of identity theft, those individuals can be provided with the same services as the named customer unless possibly, the customer has opted out. Furthermore, in the presently preferred embodiment, even the individuals who opt out of the service are provided with individual, and not family, coverage in the event that the financial institution is the source of a breach of security so that the financial services institution receives a benefit thereby potentially protecting itself should such an event occur.

### BRIEF DESCRIPTION OF THE DRAWINGS

The particular features and advantages of the invention as well as other objects will become apparent from the following description taken in connection with the accompanying drawings in which:

FIG. 1 is a flow chart showing a preferably preferred embodiment of a presently preferred process providing services to at least some customers in the Covered Group; and

FIG. 2 is a flow chart showing a suspected identity theft event as identified in FIG. 1 and how it is processed in accordance with a presently preferred embodiment of the present invention.

### DETAILED DESCRIPTION OF THE PREFERRED EMBODIMENTS

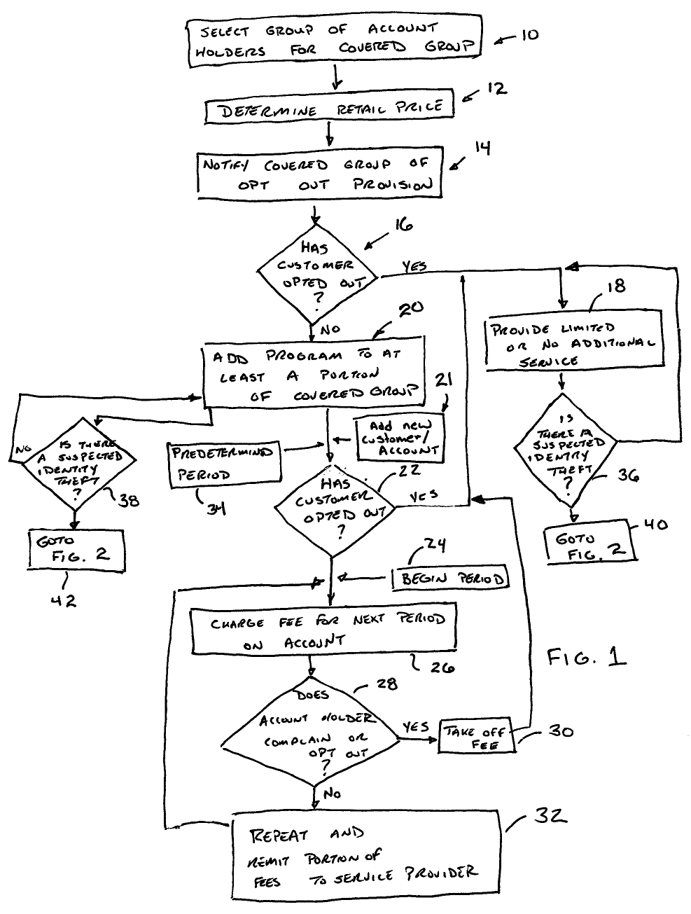

FIG. 1 shows a flow chart of a presently preferred embodiment of the present invention. At step 10 a financial organization selects at least a group of original customers to comprise a Covered Group. This could include basically any population of customers or accounts at the financial organization that they select. Financial organizations could include banks, savings and loans, credit unions, brokerages, or any other company maintaining a financial, membership or subscription account for a customer or client.

At step 12, a retail price of a new financial service is set. A final retail price could be $0.95 or other value established and includes a base price. An administration fee such as a percentage of the base price could be set or otherwise established relative thereto as an administration fee. In the event that a $0.95 base price is selected, an administration fee would be $0.19 based on a per month, per account if a 20% figure is utilized. A markup could then be added such as $0.05 or other amount which could possibly be maximized by the service provider and/or financial organization to be added to the base price or for the retail price. An example provided by the applicant was a maximum limit of $1.00 of markup for a total potential revenue stream of $1.19 per month per account for the financial service provider.

In step 14, account holders in the Covered Group identified in step 10 are notified that a program is being added as a benefit to the account. Account holders may be notified in a number of ways. Statement stuffers could be utilized. Notification could be printed on statements. Collateral mailings, newsletter articles, direct mail, e-mails or other forms of notice could also be provided. There is no specific required format for the notification in step 14. Many options are available as are known to those of ordinary skill in the art.

With the notification of step 14, an opt-out option is provided to the customers. The customers will need to take some form of affirmative action such as e-mailing a specific e-mail address, calling a specific telephone number, and/or otherwise notifying the financial organization that they elect to opt-out of the new service. If they elect to opt-out at step 16, then the customer moves to step 18 where either a limited amount of new service or no additional services are provided.

At step 20, the program or new service is preferably added to all members of the Covered Group or to the Selected Group which is defined as members of the Covered Group who have not opted out. Step 16 may or may not occur at all embodiments where shown and it may occur instead at location for step 22 and/or both of those locations as is shown in the presently preferred embodiment. However, at least some benefit will be added to either the Covered Group or the Selected Group as will be discussed in further detail below.

The benefit period begins, if it has not begun already, as shown at step 24. After a predetermined time, such as sixty days as a notification period, as shown in step 34, eventually those that have not opted out are charged the advertised retail price at step 26 for a period, such as on a statement as a service charge. During the notification period as well as possibly additional time beforehand, one or more notifications has occurred to advise the Covered Group of the inclusion of this new charge on their statements for the new service. Many financial organizations will have a service charge routine and/or fee assessment routine which tracks fees for account holders.

At this point, it is possible that a statistical amount of customers might then opt-out at step 28 thereby allowing the financial organization to remove the fee at step 30 and then provide limited or no additional services at step 18, such as if the customer had initially opted out of the services in the very beginning. If all the customers do not then opt out, then at the end of the first period such as a monthly billing cycle at step 32, the procedure returns to the beginning of a new period at step 24 to begin charging for the next period at step 26. Additionally, going back to step 30, if someone does request a refund such as a full refund, it can be performed for possibly up to a predetermined time such as up to six months or could otherwise be at the discretion of the service provider of the financial services to how long the refund could be provided. Furthermore, one may later decide to opt out at this step possibly with a limited or no refund, but stopping further deductions accompanied with a movement out of the Selected Group.

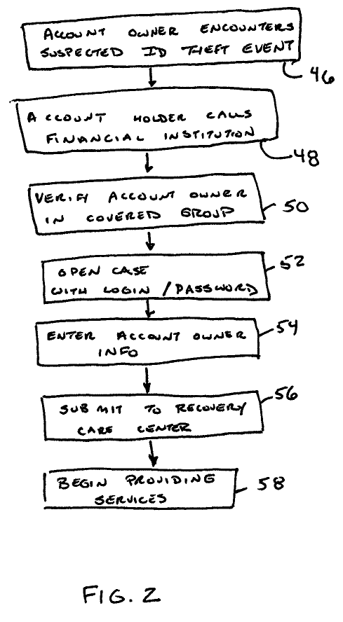

Also at step 32, such as within 15 days after the end of each month or otherwise, the financial organization could remit the total of the collected fees. The administrative fee ($0.19 in the example discussed above) along with the markup (up to a maximum of $1.00 as discussed above) and any cancellations could be subtracted before sending funds to the service provider. In the presently preferred embodiment of the present invention, no names or personal information about any of the customers is provided to the service provider. The transfer of funds for the remainder of the service which would be $0.76 per customer in the example provided. Meanwhile, if there is a suspected identity theft event such as could occur at steps 36 or 38, then in such an event, the routine of step in FIG. 2 could be utilized as a directed by steps 40 and/or 42 respectively. If not, the financial end of the matter is preferably handled in accordance with the flow chart at FIG. 1.

Should a new account and/or customer open an account which is determined to be available for inclusion in the Covered Group such as is shown in step 21, the benefits may begin immediately as shown and billed as shown in step 26 unless the customer/account opts out of the service. The financial organization may, or may not, make opting out an option for new customers/accounts in the various embodiments. Furthermore, fees may or may not be charged for new customers/accounts as they are added, even if all services provided to either the Selected Group or Covered Group are provided to the new account holder. While a notification period could be provided, it is not anticipated to be provided with a presently preferred embodiment for newly added accounts.

Unfortunately, statistically some customer's identity will ultimately likely be the subject of an identity theft event. The process shown in FIG. 2 can be instituted at steps 40 or 42 from FIG. 1. A suspected identity theft event occurs at step 46 and the customer reports the suspected identity theft event either directly to the financial organization or to the service provider. From that steps, it is preferred that the customer call the financial organization at step 48. The financial organization can then verify the customer is a member of the Covered Group or Selected Group at step 50 depending on a preferred embodiment whose identity is at issue. It is possible that, depending on which embodiment has been initiated, that the customer, even if opted out, may be still covered in a personal capacity, but possibly not with family coverage. If the family is included, three generations including the one above and the one below (i.e., parents and children) and/or other family member may be covered if in the Covered Group.

With verification that the customer is still in the Covered Group and potentially has not opted out at step 50 or is a member of the Selected Group and still covered, then a case can be opened at step 52. A login such as with a password and account owner information can be input at step 54. Account owner information could include the customer's name, telephone number, along with a preferred time to call.

At step 56 a case can be submitted to a recovery care center at which preferably provides an advocate assigned who can call to the customer at step 58 to begin the process of assisting the customer to recover their identity and to potentially undo any damage done by the stolen identity. Using this method is anticipated as a large portion if not all the customers at a financial organization may mitigate identity theft and breach damage.

The service provider of the presently preferred embodiment uses an identity theft recovery process which includes personal recovery services by at least one trained and professionally certified identity theft recovery advocate. The advocate essentially can assist and/or take over the identity recovery process for the customer. It is possible that the advocate may perform some or all the dispute process resolution with creditors, government agencies or law enforcement such as completing and tracking paperwork, etc . . . . The advocate can also perform the identity recovery preferably with the assistance of a limited power of attorney authorization and may work on behalf of the customer. This is believed to be preferable to do-it-yourself kit systems. Of course, in other embodiments, do-it-yourself kits could be provided as well, either instead of or together with the advocate having various capabilities and/or duties.

It is anticipated that the personal recovery advocate assigned may research and assess the damage to assist in making as complete of recovery process as possible. It is further anticipated a limited power of attorney authorization can allow the recovery advocate to work on the customer's behalf to perform many, if not all, the tasks required to access and manage the recovery process. A limited power of attorney authorization is expected to be limited just to the activities of discovering and reversing documented fraud. It is completely the customer's choices whether or not to utilize limited power of attorney authorization although it is not expected that many, if any, customers will reject these as benefits. With a limited power of attorney authorization, the recovery effort can work hand in hand with the customer to assist with recovery.

The advocate can perform research, phone calls, follow up and case documentation. The advocate can also contact and file information with creditors, bill collectors, banks, mortgage companies, and agencies such as the Department of Motor Vehicles, Social Security Administration and the U.S. Postal Service. The advocate can also work with federal, state and local law enforcement to gather evidence to assist in the identification, arrest and potential prosecution of the perpetrator. The advocate may also work until all theft events have been successfully addressed and expunged in the record of the customer. Additional and/or fewer benefits can be provided in other financial services packages.

It is further anticipated that family recovery possibility can be provided at no additional direct cost to customers for the Selected Group. This benefit can include assistance in identity recovery by an advocate, such as a trained FCRA-certified or paralegal identity theft advocate as described above, other provider. This service can be offered to the customer and his or her spouse or domestic partner. Potentially, all dependents of the customer such as under age 25, preferably sharing the same permanent address, even if in college or the military or others may be covered. Even the customer's parents such as those who have the same permanent address or those who live in assisted living, nursing home, hospice or other location could be included. Deceased parents who have died within the twelve months or less may also be covered in some embodiments.

Furthermore, it is possible that a 48-hour breach response can be included. In the event that the financial organization suffers an accidental or other loss of any customers' personal information such as defined in the Gramm-Leach-Bliley Act (GLBA) or otherwise, the Fully Managed Recovery Services could be available to the Covered Group, even those that opt-out. It is preferable that at least a minimum percentage of participants be in the Selected Group as could be in the Covered Group such as 60% or otherwise in order to provide this service which is specifically shown and discussed with reference to step 18 in FIG. 1.

Any type of that event may be covered including, but not limited to, malicious events, computer hacking, physical break in, employee theft, etc., or accidental events such as incorrect disposal, loss of laptop, mail room errors, etc. Services could include, but are not limited to, assessing the notification requirements for the state, drafting sample letters of notification based on the circumstances of the event, creating an action plan with timelines in order to execute the response, obtaining competitive bids for services, preferably based on volume discounts, for any of the following services: mailing and address resolution services, call center services, credit monitoring services, identity monitoring services and/or fraud alerts.

In two runs of this program, a confirmed participation rate of 93-97% were established, however, when proposing to offer the services, a much more conservative figure of 80% is typically advertised. A much more realistic and less conservative figure could be quoted in other embodiments.

When providing services, general terms and conditions may be invaluable such as identifying what identity theft comprises. One definition may include a fraud that involves the use of consumer's name, address, Social Security Number, financial services company or credit/debit card account number or other identifying information without the knowledge of the consumer and such information is then used to commit fraud or other crimes. An identity theft event can include but is not limited to any unauthorized access or use of a consumer's “non-public, personal information,” as defined by the Gramm-Leach-Bliley Act, 15 USC §6801-6809 et seq.

It may also be a good idea to limit services. Qualifying events may be limited to those first discovered by the consumer and reported to the service provider during the benefits period. Persons who have identity theft or other claims before services are initiated are preferably not eligible for services in this program, but may be allowed to purchase services from a then current rate schedule for emergency recover services.

It is further advisable to request the customer to file a police report with local law enforcement authorities in the event of an identity theft event. If the customer elects not to pursue the charges if it is a family member or other situation, the recovery advocate may not be able to fully complete all the services under their system which would need to be acknowledged by the customer. Furthermore, it may be advisable to restrict the provision of benefits to the United States where the law relative to recovery may be relatively easily known. Performing services with agencies outside the United States where U.S. law does not apply may prove difficult.

It is also advisable to possibly notify the customer that services may not include credit counseling or repair to credit. Those responsibilities generally belong to the customer.

An ability to terminate services when a customer is committing fraud or other illegal acts, making untrue statements, or is failing to perform his or her portion of the recovery plan may be a good idea. Furthermore, it is preferably stated that the service provider will not reimburse the customer for any financial losses in any account arising from identity theft.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A business method of providing theft identity services comprising the steps of:
a) identifying a group of account holders with accounts at a financial organization to be a Covered Group;
b) determining a retail price for identity theft services to be offered to the Covered Group;
c) notifying the Covered Group of the addition of the identity theft services as a service offered in connection with the accounts, and when notifying the Covered Group, advising that upon opting out, at least some portion of the service will not be provided and the retail price will not be charged to the account;
d) identifying account holders that opted out of the Covered Group and identifying the non-opting out remainder of the Covered Group as a Selected Group; and
e) providing the theft identity services to at least the Selected Group.

2. The business method of claim 1 further comprising the step of providing at least one additional benefit to the Selected Group than those that opted out of the Covered Group.

3. The business method of claim 1 wherein the theft identity services further comprises providing an advocate for a member of the Selected Group in an event of at least a suspected identity theft.

4. The business method of claim 3 wherein the advocate is provided through the steps of:
i.e., verifying a victim of at least a suspected identity theft is a member of one of the Selected Group and the Covered Group; and then
i.e., opening a case and providing theft recovery services.

5. The business method of claim 4 wherein the case is opened through the steps of the financial institution utilizing a password and login information provided by the service provider to the financial institution.

6. The method of claim 4 wherein after opening the case, account owner information is provided to the service provider for use in providing theft recovery services.

7. The method of claim 6 wherein the information comprises at least one of name, address, phone number, e-mail address and time to call.

8. The business method of claim 3 wherein the advocate, utilizing a limited power of attorney from the member, at least attempts to address issues related to the identity theft event.

9. The business method of claim 1 wherein the theft identity services are initially provided for a predetermined time to the Covered Group, and then at the end of the predetermined time, to the Selected Group.

10. The business method of claim 9 wherein the step of notifying the Covered Group is performed before or during the predetermined time.

11. The business method of claim 1 wherein all members of the Covered Group are provided with at least some identity theft services in an event of an identity theft event occurring as a result of activity by the financial organization.

12. The business method of claim 11 wherein all members of the Covered Group are provided with at least some identity theft services, providing the Selected Group comprises a predetermined portion of the Covered Group.

13. The business method of claim 12 wherein the predetermined portion is about 60%.

14. The business method of claim 10 wherein the retail price is charged for a first period after the predetermined time to members of the Selected Group.

15. The business method of claim 14 wherein if a member of the Selected Group then opts out, the retail price is restored to the account of the opting out member of the Selected Group and that member is no longer a portion of the Selected Group.

16. The business method of claim 15 wherein the retail price is multiplied by a number of accounts in the Selected Group to provide a total collected, and from the total collected an administrative fee is subtracted to provide a remittance to a service provider which at least administers the identity theft services on behalf of the financial institution, while at least the administrative fee is retained by the financial institution.

17. The business method of claim 16 wherein cancellations are subtracted from the total collected before subtracting the administrative fee.

18. The business method of claim 16 wherein the retail price further comprises an add-on profit for the financial organization and the add-on profit is subtracted from the total collected before subtracting the administrative fee.

19. A business method of providing theft identity services comprising the steps of:
a) identifying at least a group of customers with accounts at a financial institution to be a Covered Group;
b) determining a retail price for identity theft services to be offered to the Covered Group;
c) notifying the Covered Group of the addition of the identity theft services as a service offered in connection with the accounts, and when notifying the Covered Group, advising that upon opting out, at least some portion of the service and retail price will not be charged to the account;
d) identifying customers that opted out of the Covered Group and identifying the non-opting out remainder of the Covered Group as a Selected Group;
e) then providing the identity theft services to the Covered Group for a predetermined period of time without charging the retail price to the accounts; and then
f) after the predetermined period of time providing the theft identity services to the Selected Group with at least one more benefit than being provided to the Covered Group while charging the retail price to the accounts of the Selected Group.

20. The method of claim 19 wherein the retail price is charged periodically, and after a cycle, the retail price is multiplied by a number of customers in a Selected Group to provide a total collected, and then a remittance is made to a service provider from the total collected while retaining an administrative fee by the financial organization.
